(19) United States
(12) Patent Application Publication
(10) Pub. No.: US 2016/0061986 A1
(43) Pub. Date: Mar. 3, 2016

(54) Formation Property Characteristic Determination Methods

(71) Applicant: Schlumberger Technology Corporation, Sugar Land, TX (US)

(72) Inventors: Vivek Anand, Sugar Land, TX (US); Vikas Jain, Sugar Land, TX (US)

(21) Appl. No.: 14/470,052

(22) Filed: Aug. 27, 2014

(51) Int. Cl. G01V 3/32; G01V 3/38

(52) U.S. Cl. CPC G01V 3/32; G01V 3/38

(57) ABSTRACT

A method for analyzing at least one characteristic of a geological formation may include obtaining measured data for the geological formation based upon a logging tool, and minimizing an objective function representing at least an L^{p} norm of model parameters and an error between the measured data and predicted data for the objective function, wherein p is not equal to 2. The method may further include determining the at least one characteristic of the geological formation based upon the minimization of the objective function.

### BACKGROUND

Logging tools may be used in wellbores to make, for example, formation evaluation measurements to infer properties of the formations surrounding the borehole and the fluids in the formations. Common logging tools include electromagnetic tools, acoustic tools, nuclear tools, and nuclear magnetic resonance (NMR) tools, though various other tool types are also used.

Early logging tools were run into a wellbore on a wireline cable, after the wellbore had been drilled. Modern versions of such wireline tools are still used extensively. However, the desire for real-time or near real-time information while drilling the borehole gave rise to measurement-while-drilling (MWD) tools and logging-while-drilling (LWD) tools. By collecting and processing such information during the drilling process, the driller may modify or enhance well operations to optimize drilling performance and/or well trajectory.

MWD tools typically provide drilling parameter information such as weight-on-bit, torque, shock & vibration, temperature, pressure, rotations-per-minute (rpm), mud flow rate, direction, and inclination. LWD tools typically provide formation evaluation measurements such as natural or spectral gamma-ray, resistivity, dielectric, sonic velocity, density, photoelectric factor, neutron porosity, sigma thermal neutron capture cross-section, a variety of neutron induced gamma-ray spectra, and NMR distributions. MWD and LWD tools often have components common to wireline tools (e.g., transmitting and receiving antennas or sensors in general), but MWD and LWD tools may be constructed to endure and operate in the harsh environment of drilling. The terms MWD and LWD are often used interchangeably, and the use of either term in this disclosure will be understood to include both the collection of formation and wellbore information, as well as data on movement and placement of the drilling assembly.

Logging tools may be used to determine formation volumetrics, that is, quantify the volumetric fraction, typically expressed as a percentage, of each constituent present in a given sample of formation under study. Formation volumetrics involves the identification of the constituents present, and the assigning of unique signatures for constituents on different log measurements. When, using a corresponding earth model, the forward model responses of the individual constituents are calibrated, the log measurements may be converted to volumetric fractions of constituents.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method for analyzing at least one characteristic of a geological formation may include obtaining measured data for the geological formation based upon a logging tool, and minimizing an objective function representing at least an L^{p} norm of model parameters and an error between the measured data and predicted data for the objective function, wherein p is not equal to 2. The method may further include determining the at least one characteristic of the geological formation based upon the minimization of the objective function.

A related apparatus is for analyzing at least one characteristic of a geological formation and may include a memory and a processor cooperating therewith to obtain measured data for the geological formation based upon a logging tool, and minimize an objective function representing an L^{p} norm of model parameters and an error between the measured data and predicted data for the objective function, wherein p is not equal to 2. The processor may further determine the at least one characteristic of the geological formation based upon the minimization of the objective function.

A non-transitory computer-readable medium may have computer-executable instructions for causing a computer to at least obtain measured data for the geological formation based upon a logging tool, minimize an objective function including an L^{p} norm of model parameters and an error between the measured data and predicted data for the objective function, wherein p is not equal to 2, and determine the at least one characteristic of the geological formation based upon the minimization of the objective function.

### BRIEF DESCRIPTION OF THE DRAWINGS

FIG. 1 is a schematic diagram, partially in block form, of a well logging apparatus which may be used for determining characteristics of formation properties in accordance with an example embodiment.

FIG. 2 is a flow diagram illustrating method aspects for determining characteristics of formation properties in accordance with an example embodiment.

FIG. 3 is a graph illustrating minimization of the L² norm in accordance with a prior art approach.

FIG. 4 is a graph illustrating minimization of the L¹ norm in accordance with an example embodiment.

FIG. 5 is a set of inversion results for 2D NMR data, and associated 1D projections, using L² norm minimization in accordance with the prior art.

FIG. 6 is a set of inversion results for the same 2D NMR data used in FIG. 5, and associated 1D projections, but using L¹ norm minimization in accordance with an example embodiment.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Generally speaking, the present disclosure relates to a method for inversion of downhole or laboratory measurements, such as multi-dimensional NMR measurements, to predict accurate formation characteristics. The method minimizes the norm of the inversion parameters to reduce the artifacts that are often present in typical inversion results obtained by existing approaches.

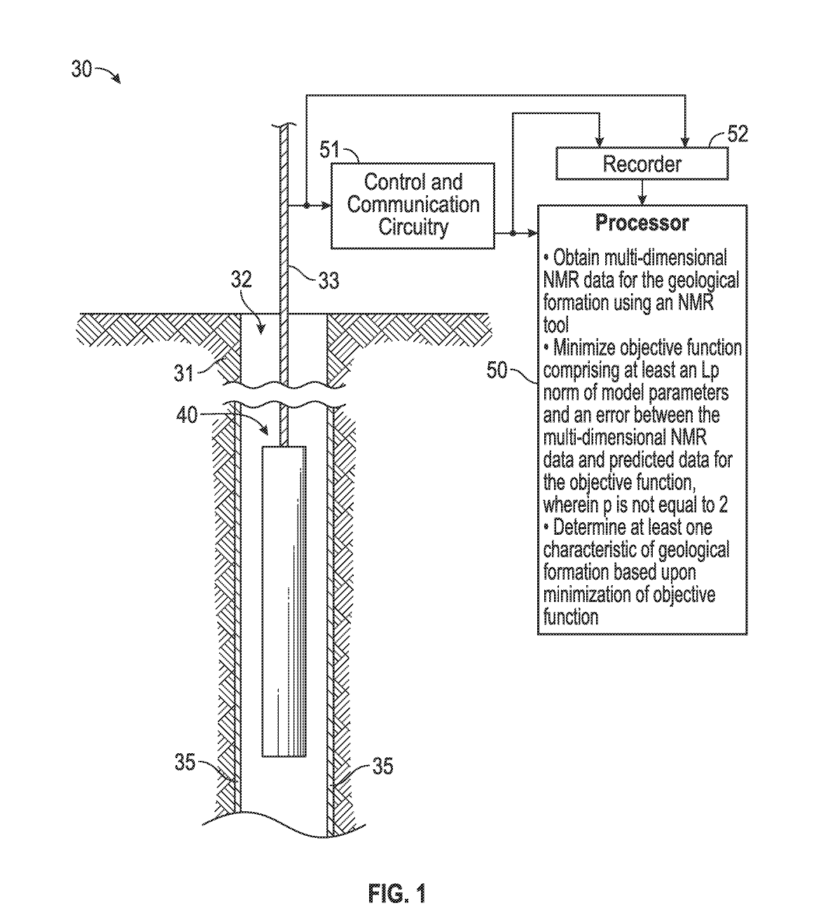

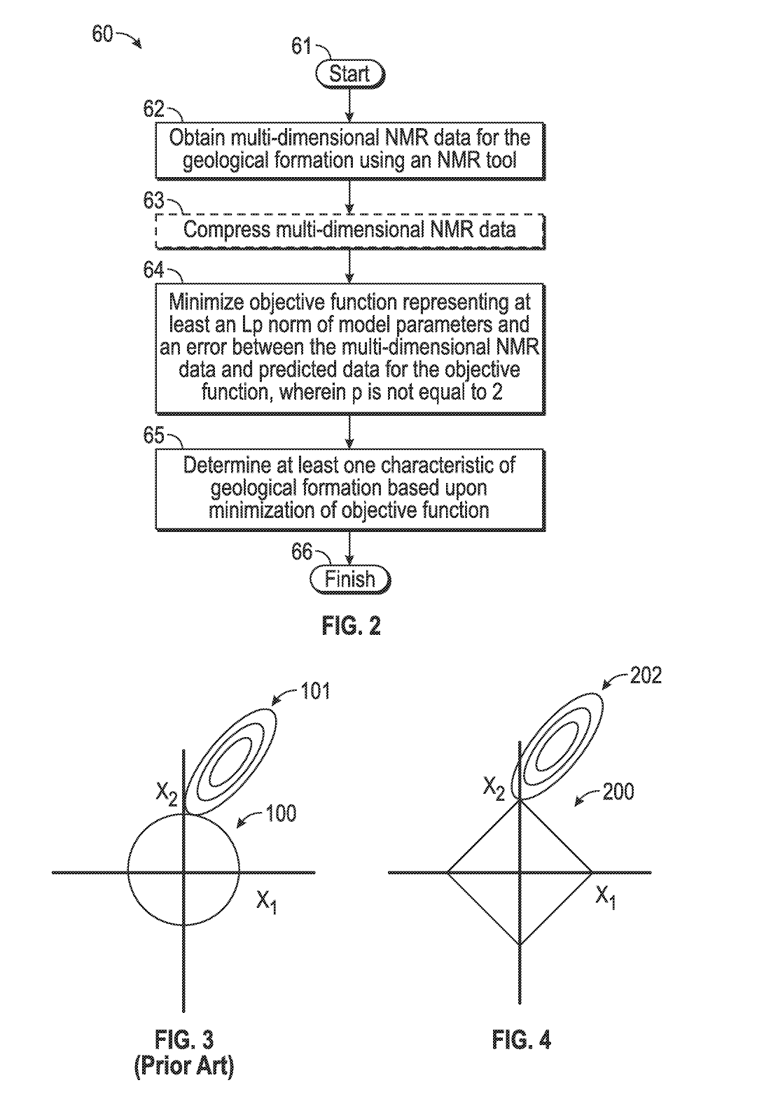

Referring initially to FIG. 1 and the flow diagram 60 of FIG. 2, an example well logging system 30 and associated method aspects are first described. Beginning at Block 61, the system 30 may be used for taking measurements (e.g., multi-dimensional nuclear magnetic resonance (NMR) data measurements) for use in determining characteristics of formation properties, such as porosity, etc., in accordance with the approach described further below (Block 62). However, it should be noted that the data may be obtained in other ways, such as through surface measurements, measurements of geological samples taken in a laboratory setting, etc., in addition to borehole measurements, and with other types of logging tools, as will be appreciated by those skilled in the art.

More particularly, a borehole 32 is drilled in a formation 31 with drilling equipment, and may use drilling fluid or mud. One or more portions of the borehole 32 may be lined with a casing 35, which may include metal (e.g., steel) cylindrical tubing, coiled tubing, cement, or a combination thereof. Other configurations may include: non-metallic casings such as fiberglass, high strength plastic, nano-material reinforced plastics, etc.; screens as used in some completions to prevent or reduce sanding; and slotted liners that may be used in completion of horizontal wells, for example. A logging device or tool 40 is suspended in the borehole 32 on an armored multiconductor cable 33 to provide a wireline configuration, although other configurations such as logging while drilling (LWD), measurement while drilling (MWD), Slickline, coiled tubing or configurations such as logging while tripping may also be used. The length of the cable 33 substantially determines the depth of the device 40 within the borehole 32. A depth gauge apparatus may be provided to measure cable displacement over a sheave wheel (not shown), and thus the depth of logging device 40 in the borehole 32.

Control and communication circuitry 51 is shown at the surface of the formation 31, although portions thereof may be downhole. Also, a recorder 52 is also illustratively included for recording well-logging data, as well as a processor 50 for processing the data. However, one or both of the recorder 52 and processor 50 may be remotely located from the well site. The processor 50 may be implemented using one or more computing devices with appropriate hardware (e.g., microprocessor, memory, etc.) and non-transitory computer-readable medium components having computer-readable instructions for performing the various operations described herein. It should also be noted that the recorder 52 may also be located in the tool, as may be the case in LWD tools, which may send a subset of data to the surface while storing the bulk of the data in memory downhole to be read out at the surface after tripping out of the hole. In Slickline implementations there may be no communication with the surface, and data will be recorded and may be processed downhole for later retrieval and potentially further processing at the surface or a remote location.

The tool 40 may include one or more types of logging devices that take measurements from which formation characteristics may be determined. For example, the logging device may be an electrical type of logging device (including devices such as resistivity, induction, and electromagnetic propagation devices), a nuclear logging device (e.g., NMR), a sonic logging device, or a fluid sampling logging device, as well as combinations of these and other devices, as will be discussed further below. Devices may be combined in a tool string and/or used during separate logging runs. Also, measurements may be taken during drilling, tripping, and/or sliding. Some examples of the types of formation characteristics that may be determined using these types of devices include the following: determination, from deep three-dimensional electromagnetic measurements, of distance and direction to faults or deposits such as salt domes or hydrocarbons; determination, from acoustic shear and/or compressional wave speeds and/or wave attenuations, of formation porosity, permeability, and/or lithology; determination of formation anisotropy from electromagnetic and/or acoustic measurements; determination, from attenuation and frequency of a rod or plate vibrating in a fluid, of formation fluid viscosity and/or density; determination, from resistivity and/or nuclear magnetic resonance (NMR) measurements, of formation water saturation and/or permeability; determination, from count rates of gamma rays and/or neutrons at spaced detectors, of formation porosity and/or density; and determination, from electromagnetic, acoustic and/or nuclear measurements, of formation bed thickness.

By way of background, the estimation of formation properties, such as porosity, from downhole or laboratory measurements typically involves the solution of inverse problems. The conventional method of solution of inverse problem involves minimization of the squared differences (i.e., L²) or error between the measurements and a theoretical model relating the measurements and formation properties. The theoretical model is in general non-linear, and is obtained theoretically or empirically.

Let the theoretical model be denoted by f which is a function of set of measurements x and model parameters β. The measurements y are therefore expressed as,

yᵢ=f(xᵢ;β)+∈ᵢ, i=1,2 . . . N (1.1)

where ∈ᵢ is the random noise on the i^{th} measurement and N is the total number of measurements. The least squares estimate of the model parameters are obtained by minimizing the squared error between the model prediction and the measurements, i.e.,

$$β = min ( {\sum }_{i} {( {y}_{i} - f ( {x}_{i} , β ) )}^{2} ) \qquad ( 1.2 )$$

In several cases, the minimization problem stated above is ill-conditioned. In other words, the problem may not have a unique solution, and may be highly dependent on the small changes in the data. In such cases, a regularization term is added to the objective function to make the inversion robust as shown below,

$$β = min ( {\sum }_{i} {( {y}_{i} - f ( {x}_{i} , β ) )}^{2} + α {\sum }_{j} {β}_{j}^{2} ) \qquad ( 1.3 )$$

The parameter α, called the regularization parameter, governs the balance between the data fit and smoothness of the estimate.

One of the difficulties with minimizing the objective function of Eq. (1.3) is that it is highly sensitive to the systematic errors or outliers. If gross or systematic errors are present in the measurements, the results of the inversion may deviate extensively from the true values of the model parameters.

The L^{p} norm of a vector is defined as:

$${‖ x ‖}_{p}^{p} = {\sum }_{i = 1}^{n} {X}^{p} \qquad ( 1.4 )$$

The objective function of Eq. (1.3) minimizes the L² norm of the residual error and model parameters. In several inverse problems, the parameter space is sparse, which means that relatively few values in the parameter space are non-zero. An example of such a problem is the multi-dimensional inversion of NMR data to obtain a joint relaxation time and diffusion distribution. For a typical D-T₂ distribution of a live-oil at elevated temperature and pressure, generally relatively few parameters in the D-T₂ space will be non-zero, while the rest will be zero.

Minimization of the L² norm of the objective function, however, does not lead to a sparse solution. This attribute of the L² minimization in two dimensions is illustrated in FIG. 3. The L² norm of a vector in two dimensions is represented by the unit circle 100 while the elliptical contours 101 represent the contours of the objective function for fixed values of the inversion parameters. The solution of the inverse problem is obtained at the point where the circle 100 first meets the contours 100 of the objective function. As is shown in the figure, the intersection point lies away from the axes, i.e., x₁ 0, x₂ 0.

If, however, an L¹ norm of the model vector is used in the objective function, it leads to a sparse solution. FIG. 4 illustrates how minimization of the L¹ norm in the objective function leads to the sparse solution in two dimensions. The L¹ norm of a vector in 2D is represented by an L¹ ball (unit square 200 rotated by 45°). The contours 201 of the objective function first meet the square 200 at the edge of the square (x₁=0).

In accordance with an example embodiment, minimization of the objective function may be performed which includes a p norm of the model parameters as shown below,

$$β = min ( {‖ ( {y}_{i} - f ( {x}_{i} , β ) ) ‖}_{2}^{2} + α ( {\sum }_{0 \leq p \leq ∞ \\ 0 \leq r \leq ∞} {‖ {λ}_{pr} {β}^{( r )} ‖}_{p}^{p} ) ) \qquad ( 1.5 )$$

The parameter α is the regularization parameter and λpr represents relative contribution of p^{th} norm of the r^{th} derivative of β. In case where r=0, λₚ controls the relative contributions of p^{th} norms. For (λ₁, λ₃, . . . , λₚ)=0 and λ₂=1, the above objective function reduces to Eq. (1.3). For example, in one embodiment the objective function has the following form:

β=min∥yᵢ−f(xᵢ,β)∥₂²+α(λ₁∥β∥₁+λ₂∥β∥₂²) (1.6)

Multi-dimensional NMR measurements provide a joint distribution of diffusion coefficient, T₁ and T₂ relaxation times of fluids in the pores of rocks. The measured NMR data, M, are related to the multidimensional distributions as follows:

M(η)=∫F(ξ)K(ξ;η)dξ+∈(η) (1.7)

In the above equation, F is the distribution corresponding to the multi-dimensional variable ξ which may include D, T₁, and T₂. The kernel K(ξ; η) depends on the pulse sequence parameters (η) and the fluid property ξ. The noise of the measurement is denoted by ∈. For example, for a three dimensional D−T₁−T₂ measurement, the measured data are given by the following expression,

$$M ( TE , TEL , WT ) = \int F ( D , {T}_{1} , {T}_{2} ) ( 1 - exp ( - \frac{WT}{{T}_{1}} ) ) exp ( - \frac{TE}{{T}_{2}} ) exp ( - \frac{{γ}^{2} {G}^{2} {DTEL}^{3}}{12} ) d ( D , {T}_{1} , {T}_{2} ) + ɛ ; \qquad ( 1.8 )$$

where WT, TE, TEL are the wait time, echo spacing and long spacing of the pulse sequence, respectively. The parameters γ and G and the gyromagnetic ratio and tool background gradient respectively.

Various approaches have been proposed to invert measured data to obtain the multi-dimensional distribution. The inversion of the equation is highly ill-conditioned, and a regularization term is added to make the solution robust in the presence of noise. A commonality of these methods is that they minimize the L² norm of the model parameters. As mentioned before, these methods lead to a non-sparse solution and are quite sensitive to systematic errors in the data.

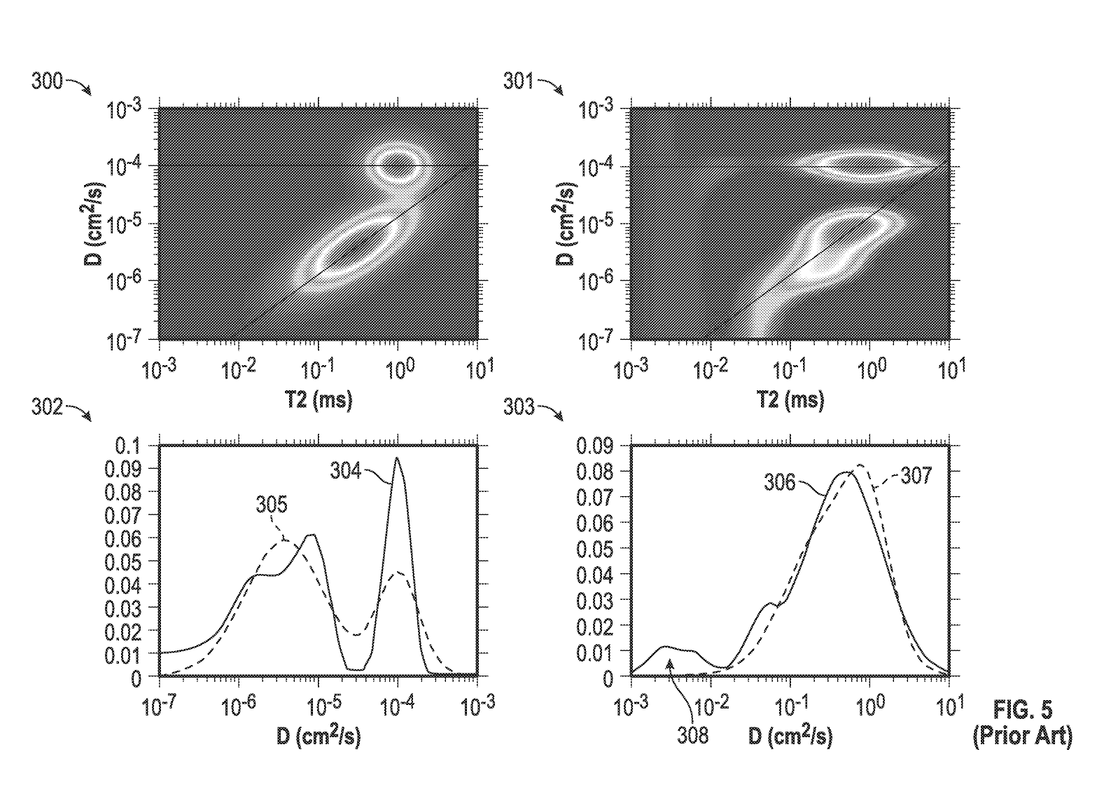

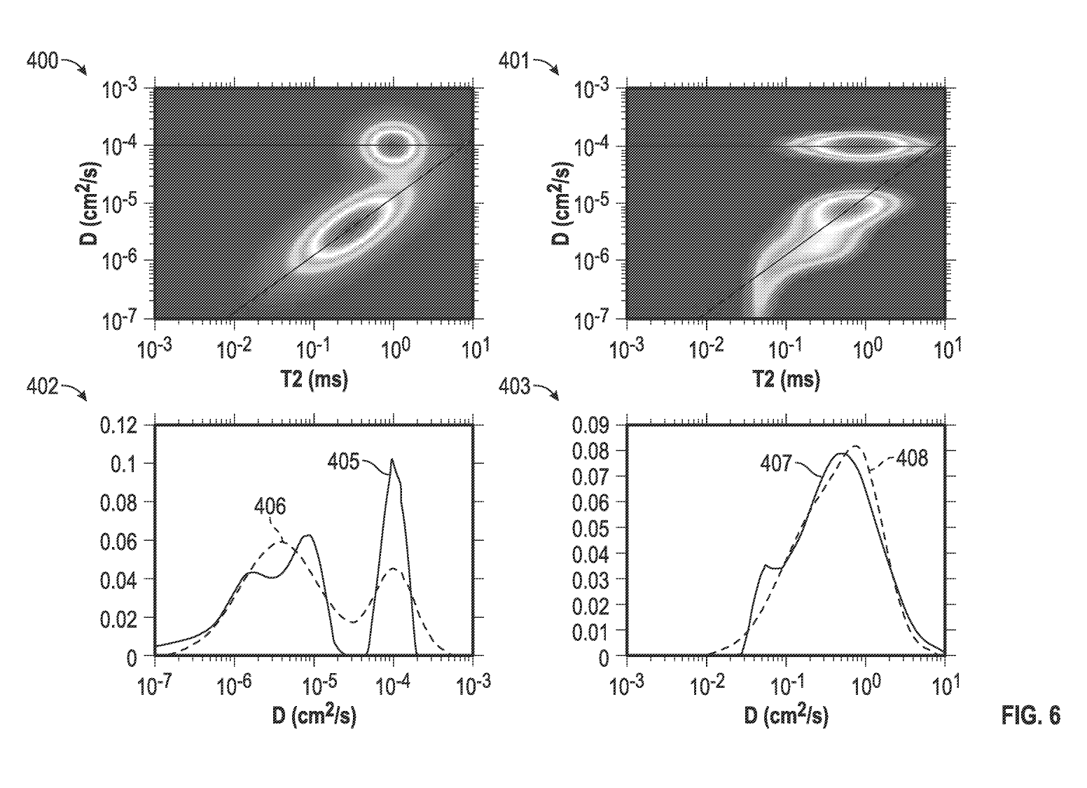

The performance of the previous approaches, which minimize solely the L² norm, versus the current approach in which minimization of a different norm not constrained to L² (e.g., L¹, L¹+L², L⁴, etc.) is performed (Block 64), was tested on a 2D synthetic data set. In the following example, minimization of the L² norm is shown in FIG. 5, while minimization of an L^{p} norm (here L¹) in accordance with the present approach is shown in FIG. 6. For this example, a model including equal volumes of water and oil was used, although other volume configurations may also be used, as will be appreciated by those skilled in the art. The relaxation time and diffusion distribution of the water component was specified to be 1 s and 10⁻⁴ cm²/sec, respectively. The oil component was specified to have a distribution of diffusion and relaxation time related by the following relationship,

D=λT₂ (1.9)

The above equation has been derived for dead oils (i.e., without dissolved gas) with the value of λ=1.25*10⁻⁵ cm²/sec². The NMR echoes corresponding to the two-dimensional distribution were computed from Eq. (1.8) for 18 different values of TEL and fixed value of TE and full polarization. Gaussian white noise was added to the synthetic echoes to represent noisy data.

The data may optionally be compressed to help reduce the inversion time (Block 63). In the present example, the data compression was performed following the window sum method described in U.S. Pat. No. 5,381,092 to Freedman, which is also assigned to the present Applicant, and which is hereby incorporated herein in its entirety, although other suitable approaches may optionally be used. The data was inverted using Eq. (1.3) and Eq. (1.6) with λ₁=1 and λ₂=0. The noise realization in both cases was kept the same to avoid any discrepancies in the inverted results due to the noise. Furthermore, the regularization parameter (α=1) was also kept the same for consistency.

First, the results for the L² minimization are examined with respect to FIG. 5. The top left panel 300 shows the model distribution, and the top right panel 301 shows the inversion D−T₂ distribution. The bottom left and right panels 302, 303 show the 1D projection of the distributions along the diffusion and relaxation time dimensions, respectively. In the panel 302, the line 304 represents predicted results and the line 305 represents actual or true results, while in panel 303 the line 306 represents predicted results, and the line 307 represents actual or true results. The 2D maps in panels 300, 301 reveal that minimizing the L² norms leads to several artifacts in the inverted distributions. In particular, the inverted distributions have an additional peak 308 at a relatively short relaxation time which is not present in the model distribution.

The result when an L¹ distance component term is used in the objective function (i.e., equation 1.6) is shown in FIG. 6. In this figure, the reference numerals 400-407 correspond to similar elements 300-307 in FIG. 5, respectively. However, it should be noted that the inverted distribution in the upper right panel 401 no longer has the artifact found at short relaxation times as in panel 301 of FIG. 5. This may be more readily seen in the panel 403, in which the peak 308 present in panel 303 of FIG. 5 is no longer present.

An approach is therefore provided for determining characteristics of geological formations from measurements made on the formations by obtaining a set of measurements using a tool situated inside or at the earth's surface (or laboratory measurements, as noted above), specifying an appropriate model relating the measurements and formation properties, and minimizing the objective function including or representing an L^{p} (e.g., L¹) norm of model parameters, in addition to the residual error between the measurements and the model predictions, as discussed further above. The formation properties (e.g., porosity, etc.) may then be obtained from the minimization, at Block 65, as will be appreciated by those skilled in the art. The method of FIG. 2 concludes at Block 66.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

1. A method for analyzing at least one characteristic of a geological formation comprising:
obtaining measured data for the geological formation based upon a logging tool;
minimizing an objective function representing at least an L^{p} norm of model parameters and an error between the measured data and predicted data for the objective function, wherein p is not equal to 2; and
determining the at least one characteristic of the geological formation based upon the minimization of the objective function.

2. The method of claim 1 wherein obtaining the measured data comprises obtaining multi-dimensional nuclear magnetic resonance (NMR) data for the geological formation based upon an NMR tool.

3. The method of claim 1 wherein p=1.

4. The method of claim 1 wherein the objective function comprises a summation of the L^{p} norm and at least one other norm.

5. The method of claim 4 wherein the at least one other norm comprises an L² norm.

6. The method of claim 1 wherein the objective function has the form:
$$β = min ( {‖ ( {y}_{i} - f ( {x}_{i} , β ) ) ‖}_{2}^{2} + α ( {\sum }_{0 \leq p \leq ∞ \\ 0 \leq r \leq ∞} {‖ {λ}_{pr} {β}^{( r )} ‖}_{p}^{p} ) ) ,$$
wherein α is a regularization parameter and λpr represents a relative contribution of the p^{th} norm of the r^{th} derivative of β.

7. The method of claim 1 further comprising compressing the measured data before minimizing.

8. The method of claim 1 wherein the at least one characteristic of the geological formation comprises porosity.

9. The method of claim 1 wherein the geological formation has a borehole therein, and wherein obtaining the measured data comprises measuring along a length of the borehole within the geological forming using the logging tool.

10. An apparatus for analyzing at least one characteristic of a geological formation comprising:
a memory and a processor cooperating therewith to
obtain measured data for the geological formation based upon a logging tool,
minimize an objective function representing an L^{p} norm of model parameters and an error between the measured data and predicted data for the objective function, wherein p is not equal to 2, and
determine the at least one characteristic of the geological formation based upon the minimization of the objective function.

11. The apparatus of claim 10 wherein the measured data comprises multi-dimensional nuclear magnetic resonance (NMR) data for the geological formation from an NMR tool.

12. The apparatus of claim 10 wherein p=1.

13. The apparatus of claim 10 wherein the objective function comprises a summation of the L^{p} norm and at least one other norm.

14. The apparatus of claim 13 wherein the at least one other norm comprises an L² norm.

15. The apparatus of claim 10 wherein the objective function has the form:
$$β = min ( {‖ ( {y}_{i} - f ( {x}_{i} , β ) ) ‖}_{2}^{2} + α ( {\sum }_{0 \leq p \leq ∞ \\ 0 \leq r \leq ∞} {‖ {λ}_{pr} {β}^{( r )} ‖}_{p}^{p} ) ) ,$$
wherein α is a regularization parameter and λpr represents a relative contribution of the p^{th} norm of the r^{th} derivative of β.

16. The apparatus of claim 10 wherein said processor cooperates with said memory to compress the measured data before minimizing the objective function.

17. The apparatus of claim 10 wherein the at least one characteristic of the geological formation comprises porosity.

18. A non-transitory computer-readable medium having computer-executable instructions for causing a computer to at least:
obtain measured data for the geological formation based upon a logging tool;
minimize an objective function representing an L^{p} norm of model parameters and an error between the measured data and predicted data for the objective function, wherein p is not equal to 2; and
determine the at least one characteristic of the geological formation based upon the minimization of the objective function.

19. The non-transitory computer-readable medium of claim 18 wherein the measured data comprises multi-dimensional nuclear magnetic resonance (NMR) data for the geological formation from an NMR tool.

20. The non-transitory computer-readable medium of claim 18 wherein p=1.

21. The non-transitory computer-readable medium of claim 18 wherein the objective function comprises a summation of the L^{p} norm and at least one other norm.

22. The non-transitory computer-readable medium of claim 21 wherein the at least one other norm comprises an L² norm.

23. The non-transitory computer-readable medium of claim 16 wherein the objective function has the form:
$$β = min ( {‖ ( {y}_{i} - f ( {x}_{i} , β ) ) ‖}_{2}^{2} + α ( {\sum }_{0 \leq p \leq ∞ \\ 0 \leq r \leq ∞} {‖ {λ}_{pr} {β}^{( r )} ‖}_{p}^{p} ) ) ,$$
wherein α is a regularization parameter and λpr represents a relative contribution of the p^{th} norm of the r^{th} derivative of β.
